(19) United States
(12) Patent Application Publication
(10) Pub. No.: US 2012/0267360 A1
(43) Pub. Date: Oct. 25, 2012

(54) ROTARY TYPE MICROWAVE HEATING FURNACE AND HEATING METHOD THEREOF

(76) Inventors: Jung Ho Park, Chungcheongnam-do (KR); Jae Yong Ryu, Daejeon (KR); Dae ju Hwang, Chungcheongbuk-do (KR); Dong-Hyun Peck, Daejeon (KR); Kye Hong Cho, Seoul (KR)

(21) Appl. No.: 13/150,803

(22) Filed: Jun. 1, 2011

(30) Foreign Application Priority Data
Apr. 22, 2011 (KR) 10-2011-0034425

(51) Int. Cl. H05B 6/78

(52) U.S. Cl. 219/700

(57) ABSTRACT

A rotary type microwave heating furnace of the present disclosure includes a cavity configured to form an airtight space to which the microwave is radiated, a microwave generation apparatus configured to radiate the microwave to the inside of the cavity, a heating element rotatably installed within the cavity in a tilted posture and configured to have the target heating subject received therein, a target heating subject supply apparatus configured to sequentially supply the target heating subjects to the heating element, a heating element rotation apparatus configured to supply power for rotating the heating element, and a control unit configured to control the amount of the target heating subject, supplied from the target heating subject supply apparatus, and the rotary velocity of the heating element performed by the heating element rotation apparatus.

### CROSS-REFERENCE TO RELATED APPLICATION

This application claims the benefit and priority to Korean patent application number 10-2011-0034425 filed on Apr. 13, 2011, the entire disclosure of which is incorporated by reference herein.

### FIELD

The present disclosure relates to a heating furnace for heating carbonate minerals, such as limestone, calcite and dolomite, by the radiation of microwave and a heating method. More particularly, the present disclosure relates to a rotary type microwave heating furnace for consecutively heating carbonate minerals while rotating the carbonate minerals and a heating method using the furnace.

### BACKGROUND

This section provides background information related to the present disclosure which is not necessarily prior art.

When carbonate minerals, such as limestone, calcite, and dolomite, are heated at high temperature, quicklime (CaO) is created through a decarbonation reaction in which carbon dioxide (CO₂) is pyrolyzed.

In the heating of the carbonate minerals (that is, the pyrolysis of the carbonate minerals), pyrolysis according to an endothermic reaction is started at about 870° C., an exothermic reaction is generated at about 950° C., and the pyrolysis is finished about 970° C.

However, in a common heating furnace, quicklime is fabricated through a decarbonation reaction in the state in which the heating time of 1 to 12 hours is maintained at a temperature higher than the pyrolysis temperature (that is, a heating temperature of 1,000° C. or higher).

A shaft kiln heating furnace and a rotary kiln heating furnace using fossil fuel, such as anthracite or petroleum, are being widely used as the heating furnace for fabricating quicklime by heating carbonate minerals.

However, the shaft kiln and rotary kiln heating furnaces generate a large amount of carbon dioxide (CO₂) known as a representative greenhouse gas during the combustion of fuel because they use fossil fuel as the heating fuel, thereby generating environmental pollution. Furthermore, with the recent exhaustion of fossil fuel, the shaft kiln and rotary kiln heating furnaces increase the cost for fabricating quicklime.

Furthermore, the use of the shaft kiln and rotary kiln heating furnaces is limited according to the size of heated carbonate minerals.

The shaft kiln heating furnace is chiefly used to heat a lump coal (120 to 80 mm in size) or an egg coal (80 to 45 mm in size). When the shaft kiln heating furnace is used to heat a nut coal (45 to 20 mm in size) or particles (20 to 5 mm in size), there is a disadvantage in that the heating ratio is low because the packing factor is high. The rotary kiln heating furnace has limits to the heating of a lump coal and an egg coal because fluid fuel, such as petroleum, is used and fuel costs are high. The rotary kiln heating furnace is chiefly used for the heating of a nut coal and particles, but is disadvantageous in that the rate of decrepitation of fabricated quicklime is high.

Meanwhile, calcite from among the carbonate minerals cannot be heated in the shaft kiln and rotary kiln heating furnaces. This is because calcite is not heated in the size of a lump and particles owing to its easily breaking crystalline structure and is thus utilized as ground calcium carbonate.

As described above, the shaft kiln and rotary kiln heating furnaces which are being widely used as heating furnaces for fabricating quicklime by heating carbonate minerals have a lot of problems, such as the generation of environmental pollution due to the use of fossil fuel, an increase of the operation costs of an apparatus, the limited size of mineral particles charged in the heating furnace, and the difficulty of heating for carbonate minerals, such as calcite. For this reason, active research is recently being done on a microwave heating furnace using not fossil fuel, but microwave as a heating heat source.

The microwave heating furnace adopts a method of heating a target heating subject through self-heating of a heating element, providing heating space, by radiating microwave to the heating element. The application of the microwave heating furnace has recently been in the spotlight because a process of combusting fossil fuel (that is, a heating heat source) is not required and the microwave heating furnace is eco-friendly and economical.

However, microwave heating furnaces developed so far, as shown in FIG. 1, are of a batch type in which a target heating subject is not consecutively heated, but is divided by a certain amount and heated in a fixed manner. The microwave heating furnaces are problematic in limited use because of the following problems.

First, when microwave is radiated with a heating element being fixed, the microwave is not uniformly radiated to the entire area of the heating element, but is concentrated on and radiated to a local area of the heating element. Accordingly, there is a problem in that a desired product (that is, quicklime) does not have a uniform heating ratio owing to the heatwave of the heating element in which temperature is not uniformly distributed into the heating element, but temperature locally rises.

Furthermore, the batch type in which a target heating subject is divided by a certain amount and then heated is problematic in that a large amount of quicklime may not be fabricated because carbonate minerals cannot be consecutively heated.

Meanwhile, the microwave heating furnace uses a method of, when a heating element is heated by generating microwave, transferring heat to a target heating subject by way of convection current and conduction in the distance of the heating element and the target heating subject. In the batch type microwave heating furnace, heat is transferred in the state in which the heating element and the target heating subject are spaced apart from each other at a predetermined interval. Upon actual heating, a heat temperature is lower than a set temperature in the target heating subject, and thus the heat temperature is difficult to rise up to a desired heating temperature. Accordingly, the batch type microwave heating furnace is problematic in that the size of a target heating subject (that is, carbonate minerals) is limited.

Because of the problems mentioned above, conventional microwave heating furnaces are solely used for heating not requiring a high heating temperature, such as in fine ceramics, as disclosed in Korean Patent Laid-Open Publication No. 2010-0102181.

### SUMMARY

This section provides a general summary of the disclosure and is not a comprehensive disclosure of its full scope or all of its features.

The present disclosure provides a microwave heating furnace and a heating method thereof, which are capable of obtaining quicklime in a uniform way and at a high heating ratio by generally uniformly raising temperature in a heating element, self-heated by microwave while providing heating space, and of performing heating without a limit to the size of carbonate minerals by freely controlling a heating temperature and the heating time for heating carbonate minerals.

In an embodiment, a rotary type microwave heating furnace according to the present disclosure includes a cavity configured to form an airtight space to which the microwave is radiated, a microwave generation apparatus installed outside the cavity and configured to radiate the microwave to the inside of the cavity, a heating element rotatably installed within the cavity in a tilted posture and configured to have the target heating subject received therein and to provide a heating room in which the target heating subject is heated by the radiation of the microwave, a target heating subject supply apparatus installed outside the cavity, connected to the inlet side of the heating element, and configured to sequentially supply the target heating subjects to the heating element, a heating element rotation apparatus installed outside the cavity, connected to the outlet side of the heating element, and configured to supply power for rotating the heating element, and a control unit configured to control the amount of the target heating subject, supplied from the target heating subject supply apparatus, and the rotary velocity of the heating element performed by the heating element rotation apparatus.

Here, the tilt angle of the heating element can be about 3° to about 5°. Oblique grooves are lengthily formed within the heating element in the length direction, and thus the target heating subject is discharged by means of feel fall due to the slope of the heating element and the rotation of the heating element. Accordingly, heating can be performed by controlling the rotary velocity of the heating element according to the size of the target heating subject. Furthermore, the target heating subject can be smoothly transferred and discharged by means of the oblique grooves formed within the heating element.

Meanwhile, an insulator is further installed between the inside of the cavity and the heating element. Accordingly, the heating ratio can be improved by preventing the microwave from passing through the insulator and heat, generated from the heating element, from being discharged from the insulator.

In another embodiment, a refractory cover made of refractory material is disposed on the inlet side of the heating element, connected to the heating element rotation apparatus, and is configured to have discharge holes, having the target heating subject discharged therefrom, formed in a circumference thereof. The refractory cover is connected to the pivot of the heating element rotation apparatus. Accordingly, the pivot can be prevented from being thermally deformed by preventing heat of the heating element from being transferred to the pivot.

In yet another embodiment, a discharge hole is formed in the insulator at a position corresponding to a position where the refractory cover is installed and is configured to discharge the target heating subject, discharged from the discharge holes of the refractory cover, outside the cavity, and a discharge pipe is penetrated from the outside of the cavity and connected to the discharge hole. Accordingly, the supply and discharge of the target heating subject to and from the heating element can be consecutively performed without an additional work.

The rotary type microwave heating furnace further includes a pair of guide rollers disposed on both sides of a lower side of the heating element and configured to support a weight of the heating element and to smooth the rotation of the heating element while coming in contact with an outer circumference of the heating element.

Meanwhile, a rotary type microwave heating method of heating a target heating subject using microwave according to the present disclosure includes, in a state in which a heating element having the target heating subject disposed therein and configured to form a heating space is rotated in a tilted posture of a predetermined angle, heating the target heating subject by radiating the microwave to the heating element.

In yet another embodiment, heating is performed by controlling the residence time (that is, heating time) of the target heating subject, charged in the heating element, through control of a rotary velocity of the heating element according to the type and size of the target heating subject through the control unit.

In yet another embodiment, a target heating subject supply apparatus for automatically supplying the target heating subject to the heating element is connected to the inlet side of the heating element, whereby during a process of heating the target heating subject while rotating the heating element, the transfer of the target heating subject to the heating element and the discharge of the heated target heating subject from the heating element are consecutively performed.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a conceptual diagram showing a conventional microwave heating furnace of a batch type (fixed type);

FIG. 2 is a lateral view of a rotary type microwave heating furnace according to an embodiment of the present disclosure;

FIG. 3 is a front view of the rotary type microwave heating furnace according to the embodiment of the present disclosure;

FIG. 4 is a cross-sectional view showing a connection relationship between a heating element rotation apparatus and a heating element installed in the cavity of the rotary type microwave heating furnace according to the embodiment of the present disclosure;

FIG. 5 is a conceptual diagram illustrating that the heating element according to an embodiment of the present disclosure has a tilted structure;

FIG. 6 is a partial perspective view showing that a refractory cover is connected to the inlet of the heating element according to the embodiment of the present disclosure;

FIGS. 7 and 8 are a lateral cross-sectional view and a front cross-section view showing a structure in which guide rollers support the heating element according to the embodiment of the present disclosure;

FIG. 9 is a block diagram showing a system constituting the rotary type microwave heating furnace according to an embodiment of the present disclosure;

FIG. 10 is a flowchart illustrating a heating method of the rotary type microwave heating furnace according to an embodiment of the present disclosure;

FIGS. 11 to 16 are XRD graphs showing quicklime or burnt dolomite fabricated according to the heating method of the rotary type microwave heating furnace according to the embodiment of the present disclosure; and

FIGS. 17 to 22 are XRD graphs showing quicklime or burnt dolomite fabricated according to the heating method of the conventional batch type microwave heating furnace.

Description of reference numerals of elements in the drawings:

| | |
|---|---|
| 10: cavity | 11a, 11b, 11c: shielding member |
| 20: microwave generation apparatus | 21: magnetron |
| 23: waveguide | 30: heating element |
| 31: heating room | 35: oblique grooves |
| 36: cover | 40: target heating subject |
| | supply apparatus |
| 41: hopper | 42: transfer pipe |
| 43: transfer screw | 44: motor |
| 50: heating element rotation apparatus | 51: pivot |
| 52: motor | 53: shaft support bearings |
| 60: control unit | 70: base frame |
| 72: collection bin | 74: discharge pipe |

### DETAILED DESCRIPTION

Some exemplary embodiments of the present disclosure will now be described in detail with reference to the accompanying drawings.

The terms or words used in the specification and the claims are not limited to or should not be construed as being typical or dictionary meanings, but should be construed as meanings and concepts which conform with the technical spirit of the present disclosure based on a principle that inventors may properly define the concepts of the terms in order to describe their disclosures using the best method.

It is to be noted that, in the following description, the terms “upper”, “lower”, “left”, “right”, “vertical”, “horizontal”, “length direction”, and their relevant terms are based on the direction shown in the figures.

Furthermore, a target heating subject (that is, a term integrating limestone, calcite, and dolomite which are the subject of heating to be described hereinafter) is used as power of carbonate minerals, such as limestone, calcite, and dolomite.

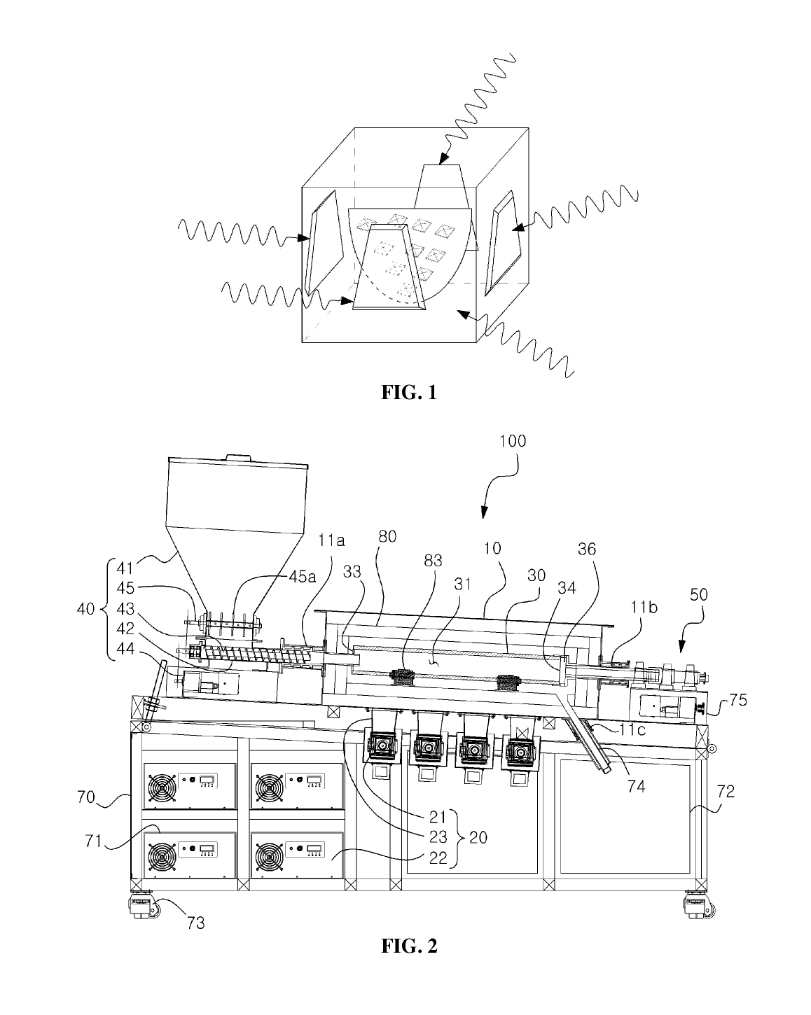

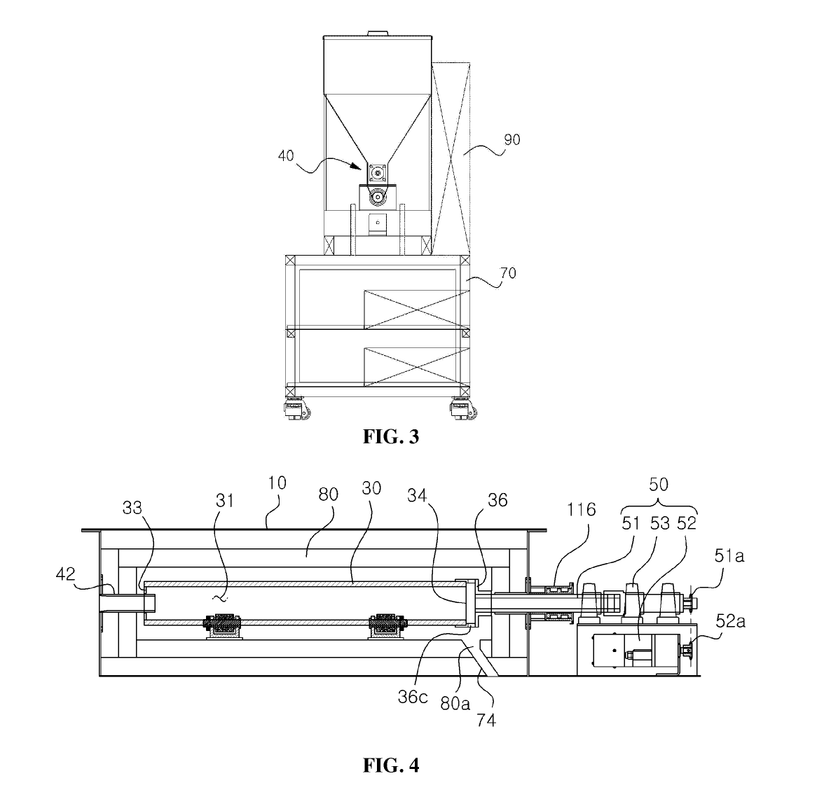

FIG. 2 is a lateral view of a rotary type microwave heating furnace according to an embodiment of the present disclosure. FIG. 3 is a front view of the rotary type microwave heating furnace according to the embodiment of the present disclosure. FIG. 4 is a cross-sectional view showing a connection relationship between a heating element rotation apparatus and a heating element installed in the cavity of the rotary type microwave heating furnace according to the embodiment of the present disclosure.

As shown in FIGS. 2 and 4, the microwave heating furnace 100 according to the present disclosure includes a cavity 10 configured to form an airtight space to which microwave is radiated, a heating element 30 disposed within the cavity 10 and configured to have microwave self-heated by radiation therein and provide a heating space (that is, a heating room 31) for a target heating subject charged in the heating space, and a microwave generation apparatus 20 disposed outside the cavity 10 and configured to radiate microwave to the inside of the cavity 10.

The present disclosure constructed as above provides the rotary type microwave heating furnace for consecutively heating the target heating subject by radiating microwave to the target heating subject in the state in which the heating element 30.

To this end, according to the present disclosure, the heating element 30 is rotatably disposed within the cavity 10. A heating element rotation apparatus 50 disposed on one side of the heating element 30 and configured to supply rotatory power of the heating element 30 and a target heating subject supply apparatus 40 disposed on the other side of the heating element 30 and configured to consecutively supply the target heating subject to the heating element 30 are disposed outside the cavity 10.

The target heating subject supply apparatus 40, the cavity 10, and the heating element rotation apparatus 50 are disposed over a base frame 70 of a square shape, installed on the ground and configured to have a predetermined height, and are sequentially connected together in the length direction of the base frame 70 (that is, from the left to the right on the basis of FIG. 2).

The base frame 70 has a tilted structure having a gradually lower height from one side in which the target heating subject supply apparatus 40 is disposed (that is, on the left of FIG. 2) toward the other side in which the heating element rotation apparatus 50 is disposed (that is, on the right of FIG. 2).

Accordingly, the target heating subject supply apparatus 40, the cavity 10, and the heating element rotation apparatus 50 disposed over the base frame 70 are installed in the form of a tilted structure the height of which is generally lowered from the target heating subject supply apparatus 40 to the heating element rotation apparatus 50. Furthermore, the heating element 30 disposed within the cavity 10 is installed in a tilted posture.

Power supply apparatuses 71 are disposed on one side of the inside of the base frame 70 and are configured to supply power to magnetrons 21 for generating microwave. A collection bin 72 is disposed on the other side of the inside of the base frame 70 and configured to take away the target heating subject that has been heated. Furthermore, a rotatable wheel 73 for moving the entire heating furnace is installed at each of the corners of the bottom surface of the base frame 70.

The cavity 10 is the airtight space to which microwave is radiated and installed in an upper middle portion of the base frame 70. The cavity 10 generally has a predetermined length and a rectangular parallelepiped shape the inside of which is empty. The cavity 10 is made of metal, such as stainless steel. Furthermore, a reflection layer may be preferably formed on the inner surface of the cavity 10 in order to improve reflection efficiency of microwave.

Furthermore, the cavity 10 is configured to generally have an airtight structure and to have a plurality of through holes formed therein such that the transfer pipe 42 of the target heating subject supply apparatus 40, the pivot 51 of the heating element rotation apparatus 50, a waveguide 23 for introducing microwave generated from the microwave generation apparatus 20, and a discharge pipe 74 for discharging the target heating subject, heated in the heating element 30, externally can be disposed within the through holes.

The heating element 30 is disposed within the cavity 10 and configured to have the target heating subject disposed therein upon heating and to provide the heating space (that is, the heating room 31) in which the target heating subject is heated. The heating element 30 is configured to have a hollow cylindrical shape with a predetermined length and rotatably installed within the cavity 10.

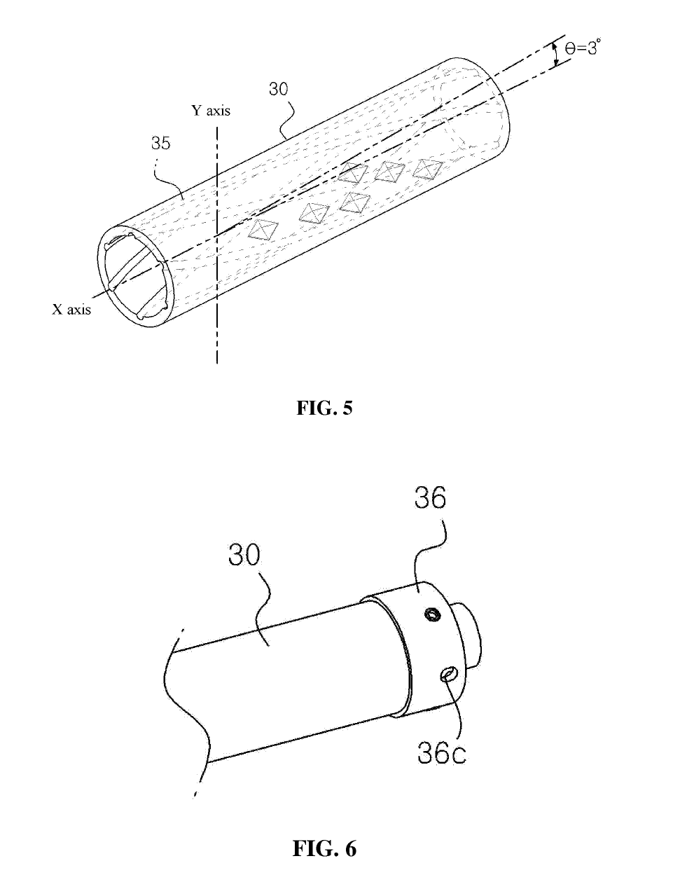

FIG. 5 is a conceptual diagram illustrating that the heating element according to an embodiment of the present disclosure has a tilted structure, and FIG. 6 is a partial perspective view showing that a refractory cover is connected to the inlet of the heating element according to the embodiment of the present disclosure.

As shown in FIG. 5, the heating element 30, as described above, is installed with slope on the basis of a horizontal plane in its entire length. More particularly, the heating element 30 is downward installed with slope from an inlet 33 through which the target heating subject is supplied to an outlet 34 from which the heated target heating subject is discharged.

According to the present disclosure, the target heating subject introduced into the heating element 30 is discharged by a height difference between the inlet 33 and the outlet 34 of the heating element 30 and the rotation of the heating element 30 in accordance with a rotary type heating method in which the heating element 30 is self-heated by the radiation of microwave while rotating at a predetermined angle in a tilted posture, thus heating the target heating subject accommodated therein.

The tilt angle of the heating element 30 is about 3° to about 5°. The angles have been derived such that the target heating subject charged in the heating element 30 is led to the outlet 34, placed at the end of the heating element 30, by way of free fall due to gravity. If the tilt angle is smaller than about 3°, free fall is not easily generated. If the tilt angle is greater than about 5°, it is difficult to control the heating time (that is, the residence time of the target heating subject within the heating element) at the rotary velocity of the heating element as will be described later. Furthermore, if the tilt angle is greater than 5°, there are problems in that it becomes difficult to maintain the radiation distance of microwave from the microwave generation apparatus and the entire volume is increased.

Furthermore, oblique grooves 35 are consecutively formed in the inner surface of the heating element 30 in a circumferential direction and are downward tilted from the inlet 33 of the heating element 30 to the outlet 34 thereof. The oblique grooves 35 makes the flow property better in the direction of the outlet 34 because the target heating subject is caught on the grooves 35 when the heating element 30 is rotated, thereby being capable of more smoothly discharging the target heating subject.

The heating element 30 is made of SiC, Si₃N₄, or the like which is self-heated by the radiation of microwave.

As described above, according to the present disclosure, the heating element 30 for providing the heating room 31 for the target heating subject is rotatably installed within the cavity 10 in a tilted posture, and thus heat is transferred in the state in which the target heating subject charged in the heating element 30 always comes in contact with the inner wall of the heating element 30. Accordingly, there is an advantage in that heating temperature can be raised as compared with a conventional method of fixing the heating element.

In particular, as the heating element 30 is rotated 360°, microwave is uniformly radiated to the entire portion of the heating element 30, so that temperature is uniformly distributed into the entire heating element 30. Accordingly, the target heating subject can be uniformly heated because there is no heat wave in which temperature at some parts of the heating element abnormally rises.

Meanwhile, as shown in FIG. 6, a cover 36 is provided in the outlet 34 of the heating element 30 connected to the heating element rotation apparatus 50. The cover 36 is connected to the pivot 51 of the heating element rotation apparatus 50 and configured to cover the opened end of the heating element 30.

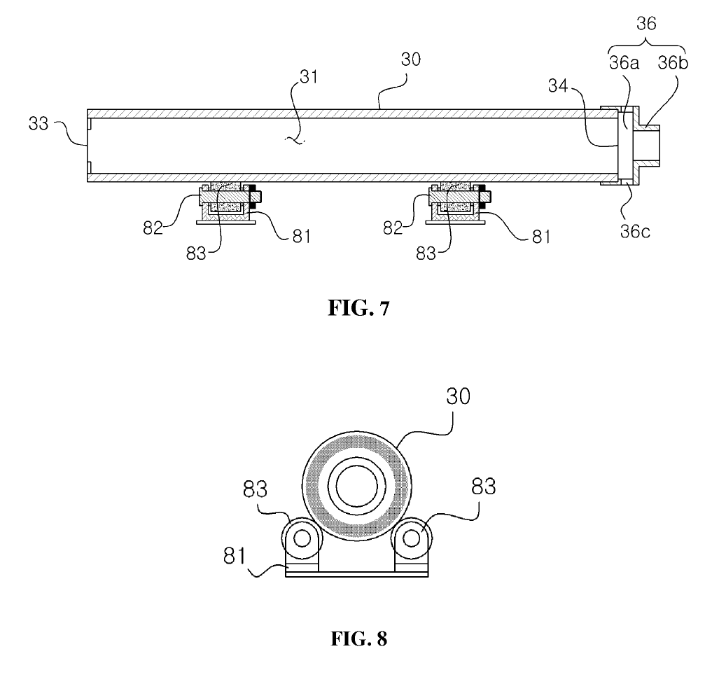

Furthermore, as shown in FIG. 7, a stepped reception groove 36a is formed in front of the cover 36 and configured to have the heating element 30 inserted therein. A shaft hub 36b having the pivot 51 inserted therein and coupled thereto is formed in the rear of the cover 36 and is outward protruded. The heating element 30 is connected to the cover 36 with it being inserted into only a large-diameter portion of the reception groove 36a. A plurality of discharge holes 36c is perforated at regular intervals in a circumferential direction on the side of a small diameter portion of the reception groove 36a into which the heating element 30 is not inserted. Accordingly, the heated target heating subject is discharged toward an insulator 80 through the discharge holes 36c.

The cover 36 is made of refractory substance, thus blocking the heat of the heating element from being conductive to the pivot 51.

Furthermore, as shown in FIGS. 7 and 8, a pair of guide rollers 83 are disposed on the left and right sides below the heating element 30 and are configured to support the weight of the heating element 30 while coming in contact with an outer circumference of the heating element 30 and also to help the smooth rotation of the heating element 30. The pair of guide rollers 83 are disposed at regular intervals on the basis of the center of the heating element 30 in a length direction thereof.

The guide rollers 83 are made of refractory substance in order to prevent them from being damaged by heat of the heating element 30.

The number of guide rollers 83 may be different according to the length of the heating element 30. For example, when the length of the heating element 30 is long, a plurality of pair of guide rollers 83 may be installed at regular intervals in the length direction of the heating element 30. When the length of the heating element 30 is short, only the pair of guide rollers 83 may be installed only in the middle portion of the heating element 30.

Each of the guide rollers 83 is rotatably installed around a support shaft 82 which horizontally penetrates a bracket 81 fixed to the inner face of the insulator 80.

Meanwhile, as shown in FIGS. 2 and 4, the insulator 80, having a square cross section and an empty inside, is installed between the heating element 30 and the cavity 10 and is configured to surround the entire heating element 30. Here, the insulator 80 functions to prevent heat, generated in the heating element 30 when microwave is transmitted, from being discharged outside the cavity 10.

The insulator 30 has a generally airtight structure. A hole through which the pivot 51 of the heating element rotation apparatus 50 penetrates and a hole through which the transfer pipe 42 of the target heating subject supply apparatus 40 are formed on both ends of the insulator 80, respectively. In particular, a discharge hole 80a is formed at a position corresponding to the position in which each of the discharge holes 36c of the cover 36 are formed and is configured to discharge the target heating subject, discharged from the discharge holes 36c of the cover 36, outside the cavity 10. The discharge hole 80a is connected to the discharge pipe 74 for guiding the target heating subject to a target heating subject collection bin 72 provided in he base frame 70.

The target heating subject supply apparatus 40, as shown in FIG. 1, further includes a hopper 41, a transfer screw 43, and a motor 44. The target heating subject is inputted to and stored in the hopper 41. The transfer pipe 42 has one end connected to the bottom of the hopper 41 and the other end connected to the cavity 10. The transfer pipe 42 is connected to the inlet 33 of the heating element 30 and is configured to transfer the target heating subject, supplied from the hopper 41, to the inside of the heating element 30. The transfer screw 43 is rotatably installed within the transfer pipe 42 and lengthily installed up to the inlet side of the heating element 30. The motor 44 provides rotatory power of the transfer screw 43.

A shaft structure 45 is rotatably installed under the hopper 41 to which the transfer pipe 42 is connected and is configured to have a plurality of blades 45a provided therein at regular intervals in an outer circumference thereof. Here, the blades 45a provided in the shaft structure 45 stir the target heating subject loaded over the transfer pipe 42 by means of the rotation of the shaft structure 45, thus helping the target heating subject to be smoothly supplied to the inside of the transfer pipe 42 (that is, the transfer screw 43).

The transfer screw 43 is configured to have one end supported by a bearing and is rotatably installed within the transfer pipe 42. A first sprocket (not shown) is installed at the end of the transfer screw 43 and is connected to a sprocket (not shown), provided in the pivot of the motor 44, by means of a chain, thus being supplied with rotatory power from the sprocket in the pivot of the motor 44.

Meanwhile, a second sprocket (not shown) is further installed at the end of the transfer screw 43 and is connected to a sprocket (not shown), installed at the end of the shaft structure 45 connected to the bottom of the hopper 41, by means of a chain.

Accordingly, when the motor 44 is rotated, the transfer screw 43 and the shaft structure 45, electrically moved together with the transfer screw 43, are rotated.

The heating element rotation apparatus 50, as shown in FIGS. 2 and 4, includes the pivot 51 configured to have one end to penetrate the inside of the cavity 10 and axially connected to the cover 36 of the heating element 30, the motor 52 configured to supply rotatory power to the pivot 51, and shaft support bearings 53 configured to smooth the rotation of the pivot 51 and also to support and fix the pivot 51 thereto.

Here, the transfer of motive power of the pivot 51 by means of the motor 52 is performed by sprockets 51a and 52a provided in the pivot 51 and the motor 52, respectively, and a chain structure connecting the sprockets 51a and 52a.

A plurality of the shaft support bearings 53 is fixed and installed at regular intervals at the top of a motor interior box 75 disposed over the base frame 70.

The microwave generation apparatus 20, as shown in FIG. 1, includes the magnetrons 21 each embedded within the airtight box connected to the end of the waveguide 23 provided under the cavity 10 and configured to substantially generate microwave and microwave power supply apparatuses 22 electrically connected to the magnetrons 21 and configured to supply power to the magnetrons 21.

In the present disclosure, the number of magnetrons 21 may be, for example, 4, and the plurality of magnetrons 21 are installed at regular intervals and are supported by the base frame 70 under the cavity 10.

The structure and radiation principle of the magnetron are known in the art, and a detailed description thereof is omitted.

Meanwhile, in the present disclosure, shielding members 11a, 11b, and 11c are installed in the transfer pipe 42 of the target heating subject supply apparatus 40, the pivot 51 of the heating element rotation apparatus 50, and a connection portion of the cavity 10 through which the discharge pipe 74 for guiding the discharge of the target heating subject penetrates, respectively, and are configured to prevent microwave, radiated toward the inside of the cavity 10 and heat generated by the heating element 30, from being discharged outside the cavity 10 (refer to FIG. 2).

Furthermore, a control box 90 (refer to FIG. 3) is installed over the base frame 70. A power unit for supplying power to the entire heating furnace, an input unit for inputting a type and size of the target heating subject, the heating time, and the radiation intensity and radiation hour of microwave, and a control unit 60 for controlling a relevant driving unit based on the input data inputted to the input unit are embedded in the control box 90.

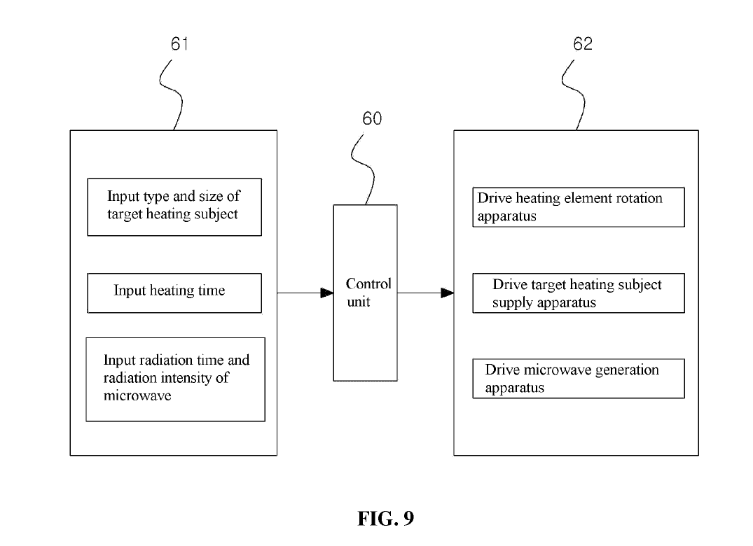

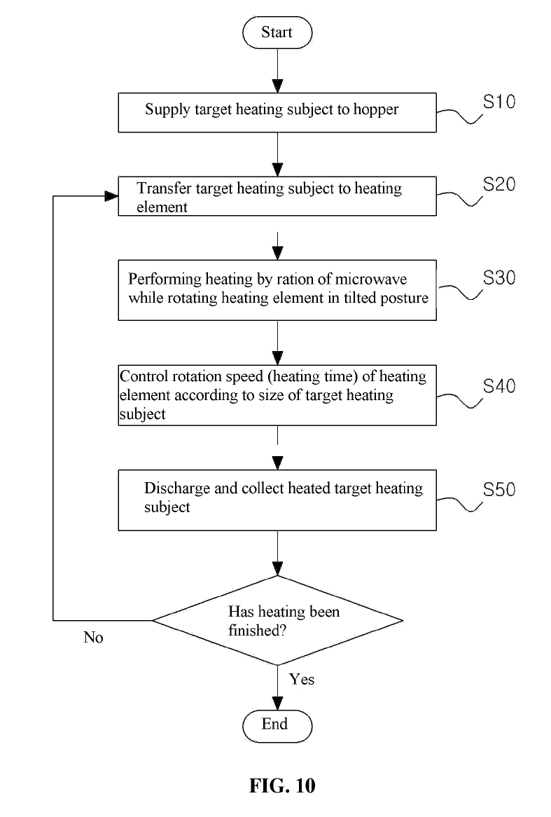

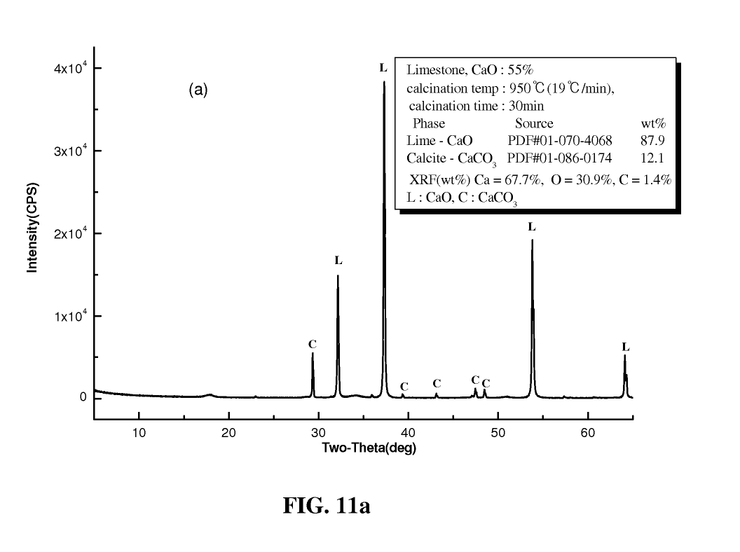

As shown in FIG. 9, when a user inputs a type and size of the target heating subject, the heating time, and the radiation intensity and radiation hour of microwave through the input unit 61, the control unit 60 controls the motor 52 of the heating element rotation apparatus 50, the motor 44 of the target heating subject supply apparatus 40, and the driving units 62 of the magnetrons 21 of the microwave generation apparatus 20 based on the inputted data such that the heating time of the target heating subject disposed within the heating element 30 is controlled according to control of the rotary velocity of the heating element 30 based on the type and size of the target heating subject and the amount of the target heating subject inputted to the heating element 30 and the radiation intensity and radiation hour of microwave are controlled.

A heating method of the rotary type microwave heating furnace constructed as described above is described below.

FIG. 10 is a flowchart illustrating the heating method of the rotary type microwave heating furnace according to an embodiment of the present disclosure.

First, the target heating subject is supplied to the hopper 41 at step S10. Here, the target heating subject is power of carbonate minerals, such as limestone, dolomite, and calcite, and the particle size of the type of the target heating subject is varied according to the type and quality of desired quicklime (CaO).

The target heating subject supplied to the hopper 41 is inputted to the transfer pipe 42 and then supplied to the heating element 30 by means of the rotation of the transfer screw 43 at step S20. Here, the amount of the target heating subject sequentially supplied through the transfer screw 43 is filled about 10 to 20% of the entire space of the heating element 30.

If about 20% or higher of the heating element 30 is filled with the target heating subject, an internal partial pressure rises owing to the discharge of carbon dioxide through a decarbonation reaction due to the heating temperature and heating time of the carbonate minerals, so that the decarbonation reaction is rarely generated. Furthermore, if less than 10% of the heating element 30 is filled with the target heating subject, the internal partial pressure is lowered owing to the discharge of carbon dioxide due to the decarbonation reaction of the carbonate minerals, so that carbon dioxide is easily discharged. Accordingly, a surface of quicklime (CaO) becomes death lime.

Next, when microwave is radiated by the heating element 30 in the state in which the heating element 30 is rotated within the cavity 10 in a tilted posture ranging from 3° to 5°, the target heating subject charged in the heating element 30 is heated by the heat of the heating element 30 at step S30.

Next, the rotary velocity (that is, the heating time) of the heating element 30 is controlled according to the size of the target heating subject, charged in the heating element 30, through the control unit 60 at step S40.

In other words, the residence time (that is, the heating time) that the target heating subject is taken to be discharged while freely falling at the tilted angle of the heating element 30 may be controlled by the rotary velocity of the heating element 30 according to the size of the target heating subject. If the rotary velocity of the heating element 30 is high, the residence time (that is, the heating time) is short. If the rotary velocity of the heating element 30 is low, the residence time (that is, the heating time) is long.

For example, in the case where the size of the target heating subject (that is, carbonate minerals) is a lump coal (80 to 120 mm), heating may be performed by lowering the rotary velocity of the lump coat in order to increase the heating time (about 6 to 24 hours). In the case where the size of the carbonate minerals is an egg coal (45 to 80 mm), heating may be performed by increasing the rotary velocity faster than the rotary velocity of the lump coal in order to maintain the heating time (about 3 to 6 hours) shorter than the heating time of the lump coal. In the case where the size of the carbonate minerals is a nut coal (20 to 45 mm), heating may be performed by making the rotary velocity faster than the rotary velocity of the egg coal in order to maintain the heating time (about 2 to 3 hours) shorter than the heating time of the egg coal. In the case where the size of the carbonate minerals is particles (5 to 20 mm), heating may be performed by making the rotary velocity of the particles faster than the rotary velocity of the nut coal in order to shortly maintain the heating time (about 1 to 2 hours).

That is, appropriate heating may be performed by differently maintaining the heating time while controlling the rotary velocity of the heating element 30 according to the size (that is, the lump coal, the egg coal, the nut coal, or the particles) of the target heating subject (that is, carbonate minerals).

Finally, the target heating subject that has been heated according to the residence time (that is, the heating time) suitable for the rotary velocity of the heating element 30 is discharged through the outlet of the heating element 30 and then stored in the collection bin 72, provided outside the cavity 10, through the discharge pipe 74 at step S50.

In the present disclosure, in the process of the target heating subject being heated while the heating element 30 is rotated, the transfer of the target heating subject to the heating element 30 and the discharge of the heated target heating subject from the heating element 30 are consecutively performed.

As described above, according to the present disclosure, the heating element 30 for providing the heating space for the target heating subject is rotatably installed within the cavity 10 in a tilted posture. Accordingly, the heating time can be maintained by controlling the rotary velocity according to the size of the target heating subject, and thus a desired product (quicklime) of a uniform heating ratio can be obtained without a limit to the size of the target heating subject (that is, carbonate minerals).

Hereinafter, Embodiments pertinent to the fabrication of quicklime using the rotary type microwave heating furnace of the present disclosure and Comparative Examples of a conventional batch type (i.e., batch type) microwave heating furnace, performed under the same conditions as those of the Embodiments, are compared with each other.

Prior to the description, a heating ratio according to the heating of carbonate minerals is described in short below. The heating ratio refers to a ratio that carbonate minerals are pyrolyzed, thus becoming CaO (quicklime). Lime stone and calcite of the carbonate minerals are composed of CaCO₃, and pure limestone and calcite are composed of CaO of 56% and CO₂ of 44%.

However, limestone or calcite existing in a natural state contains impurities. Thus, when the impurities are 1 to 2%, limestone or calcite is high-quality limestone or calcite in which CaO of 55% or 54% is contained. When the impurities are 3 to 4%, limestone or calcite is middle-quality limestone or calcite in which CaO of 53% or 52% is contained. When the impurities are 4% or less, limestone or calcite is middle-quality limestone or calcite in which CaO of 51% or less is contained.

The heating ratio of limestone or calcite, containing the impurities, leads to a weight reduction, that is, CaCO₃ is decarbonated at 950° C., thus becoming CaO. When carbon dioxide is discharged 100%, the heating ratio is 100%. In other words, CaO is 100%. According to XRD analysis, when CaCO₃ of a predetermined % exists, unheated limestone or calcite (that is, limestone or calcite not subjected to a decarbonation reaction) is contained.

Heating ratio(%)=(weight of lost CO₂ upon heating/initial weight of CO₂ in limestone)×100

However, XRD quantitative analysis is performed in the rotary type and the consecutive type because the above heating ratio equation is difficult to be used in the rotary type and the consecutive type. If CaO or CaCO₃ analyzed by the XRD quantitative analysis has a predetermined percent (%), the result is almost identical with a value found by the heating ratio. That is, when the heating ratio is 95%, it means that CaCO₃ has not been heated by about 5%.

The same principle applies to dolomite. However, dolomite is nonmetallic minerals composed of CaCO₃ and MgCO₃. Pure dolomite contains CaO of 30.4%, MgO of 21.7%, and CO₂ of 47.9%. MgCO₃ is first pyrolyzed and subjected to a decarbonation reaction at about 800° C., thus emitting CO₂, and pyrolyzed at about 950° C., thus emitting CO₂.

Likewise described above, when CaCO₃ remains as a result of the XRD quantitative analysis, heating has not been performed.

Component result XRFs of carbonate minerals (limestone and dolomite) which may be used to fabricate quicklime and burnt dolomite in embodiments and Comparative Examples applied to Examples 1 to 4 of the present disclosure are listed in Table 1 below.

TABLE 1

| Sample | Component (Unit: mass %) | | | | |
|---|---|---|---|---|---|
| Sample | Al₂O₃ | CaO | Fe₂O₃ | MgO | SiO₂ |
| Limestone (a) | 0.015 | 55.751 | 0.064 | 0.186 | 0.027 |
| Limestone (b) | 0.011 | 53.486 | 0.102 | 0.203 | 3.366 |
| Limestone (c) | 0.133 | 52.375 | 0.252 | 1.580 | 2.133 |
| Dolomite | 0.389 | 29.948 | 0.118 | 21.591 | 0.214 |
| Calcite | 0.137 | 54.3 | 0.302 | 0.413 | 0.362 |

### Example 1

### Fabrication of Quicklime

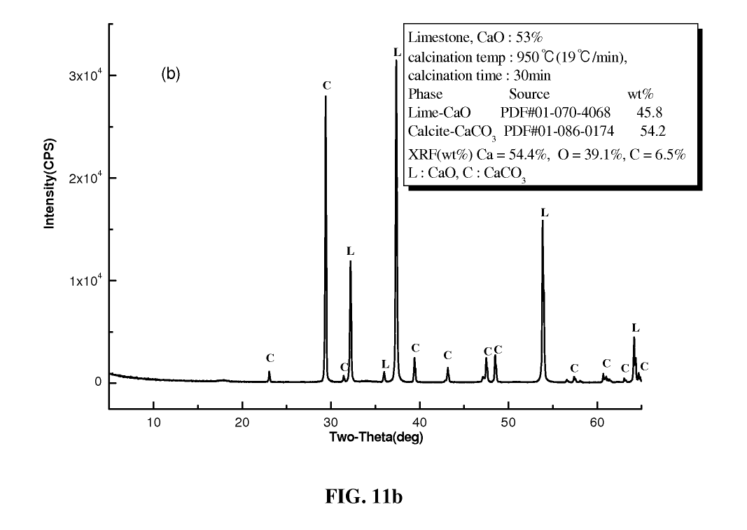

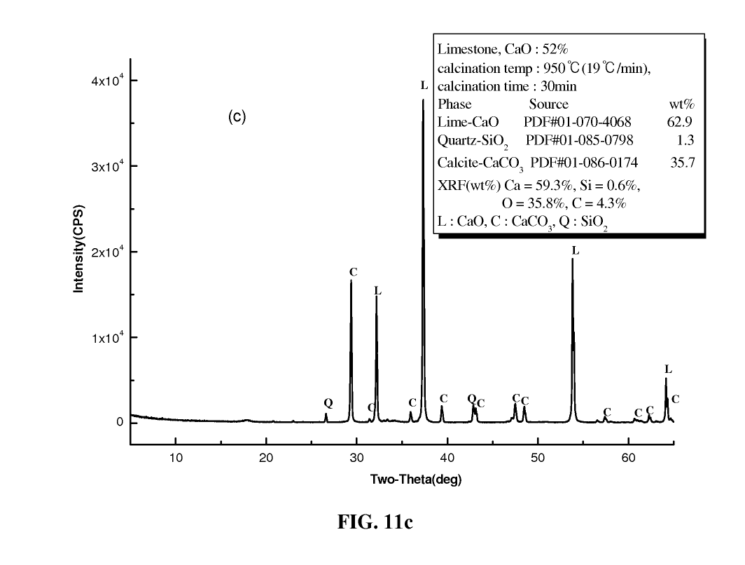

FIGS. 11a to 11c show XRD figures of quicklime which was fabricated by heating limestone of 25 mm in size (CaO: 55% (a), 53% (b), and 52% (c)) at a heating temperature of 950° C. during the heating time of 30 minutes in the state in which the heating element 30 was rotated at a tilt angle of 3° using the rotary type microwave heating furnace of the present disclosure (Embodiment 1)

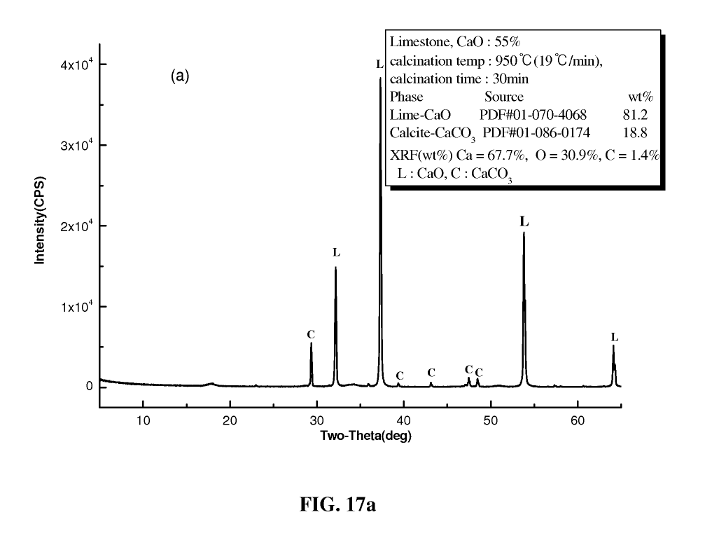

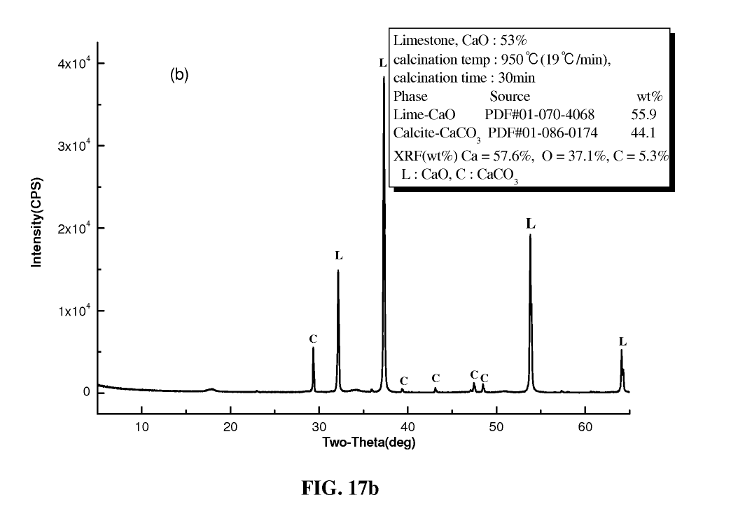

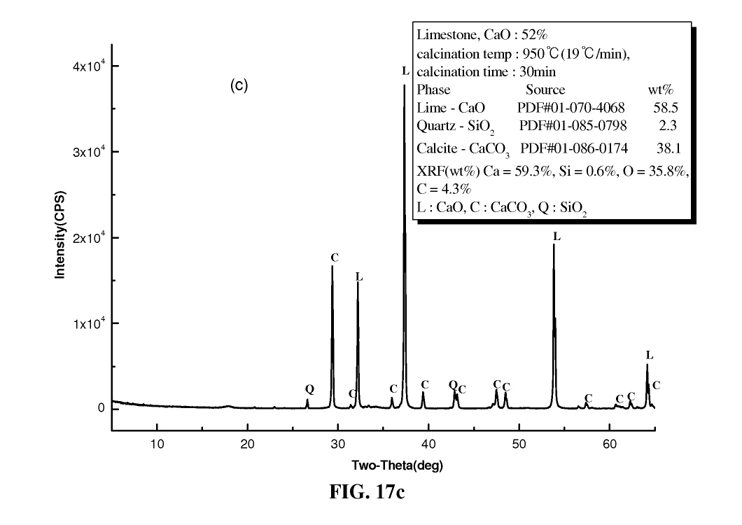

FIGS. 17a to 17c show XRD figures of quicklime which was fabricated by heating limestone of 25 mm in size (CaO: 55% (a), 53% (b), and 52% (c)) at a heating temperature of 950° C. during the heating time of 30 minutes using a conventional batch type microwave heating furnace (Comparative Example 1).

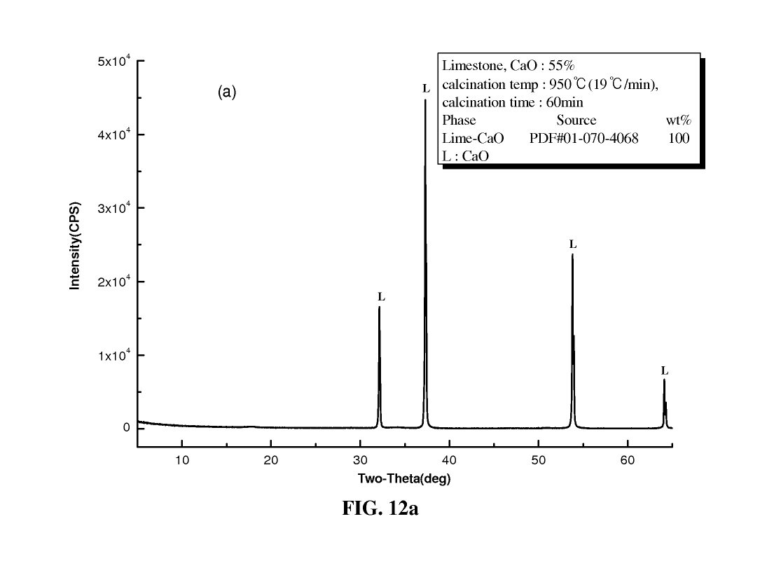

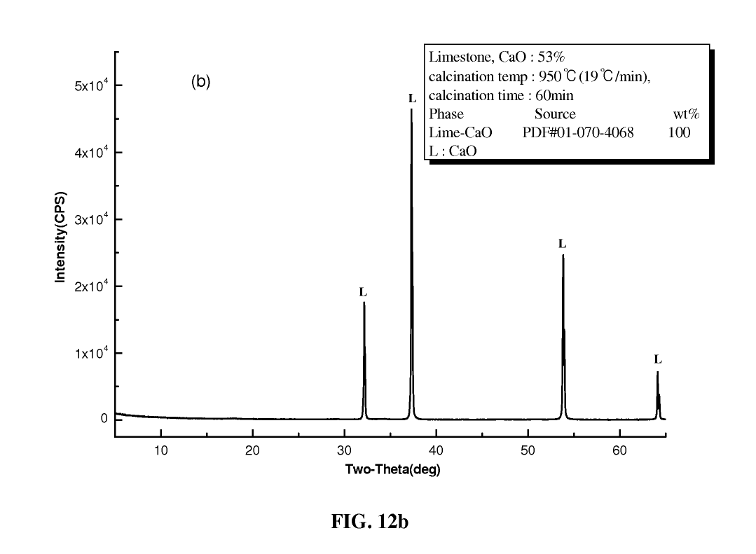

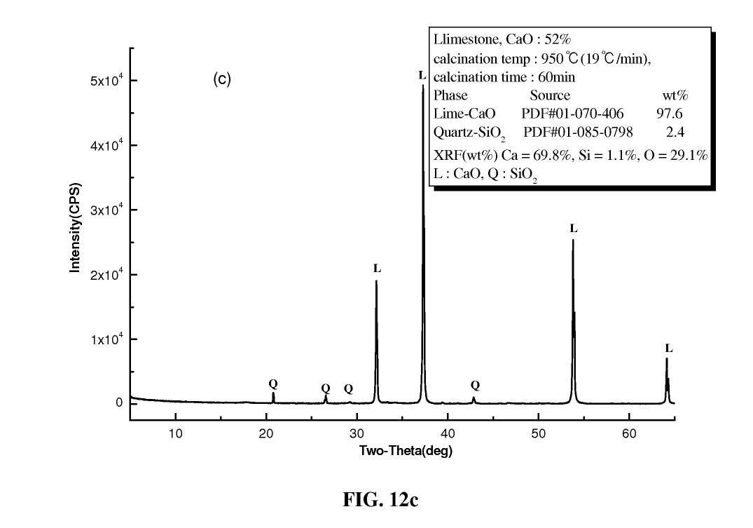

In the XRD graphs of FIGS. 11a to 11c and FIGS. 17a to 17c, an X axis indicates the degree of diffraction according to a crystalline phase, such as CaCO₃, CaO, and MgO according to the diffraction of X rays, and an Y axis indicates the intensity of the degree of diffraction (angle) according to a crystalline phase of CaCO₃, CaO, and MgO. This is the same in the XRD graphs of FIGS. 12 to 22.

Heating ratios according to experimental results of the present disclosure and of the Comparative Example shown in FIGS. 11a to 11c and FIGS. 17a to 17c are shown in Table 2 below.

TABLE 2

| | | (b) 53% | (c) 52% |
|---|---|---|---|
| | (a) 55% (limestone) | (limestone) | (limestone) |
| Comparative | CaO: 81.2% | CaO: 55.9% | CaO: 58.5% |
| Example 1 | CaCO₃: 18.8% | CaCO₃: 44.1% | CaCO₃: 38.1% |
| | | | SiO₂: 2.3% |
| Embodiment 1 | CaO: 87.9% | CaO: 45.8% | CaO: 62.9% |
| | CaCO₃: 12.1% | CaCO₃: 54.2% | CaCO₃: 135.7% |
| | | | SiO₂: 1.3% |

From Table 2, it can be seen that, except limestone of 53%, the heating ratios of the rotary type microwave heating furnace according to the present disclosure are more excellent than the heating ratios of the existing batch type microwave heating furnace.

### Example 2

### Fabrication of Quicklime

FIGS. 12a to 12c show XRD figures of quicklime which was fabricated by heating limestone of 25 mm in size (CaO: 55% (a), 53% (b), and 52% (c)) at a heating temperature of 950° C. during the heating time of 60 minutes in the state in which the heating element 30 was rotated at a tilt angle of 3° using the rotary type microwave heating furnace of the present disclosure (Embodiment 2).

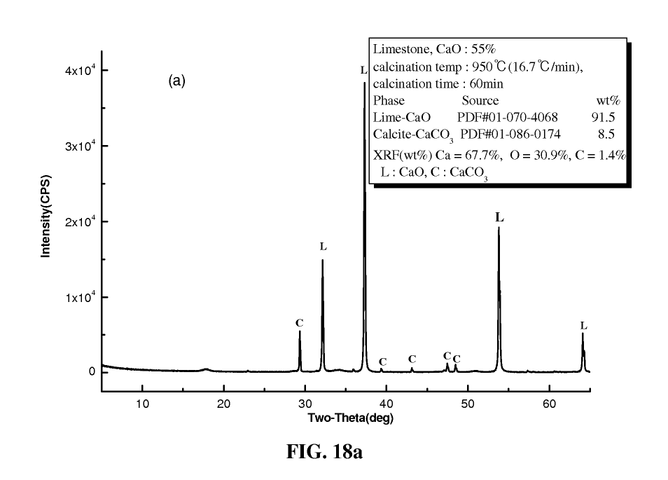

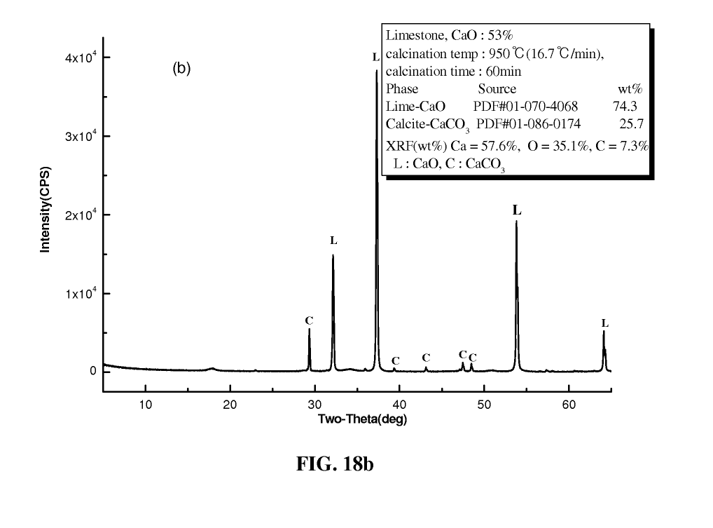

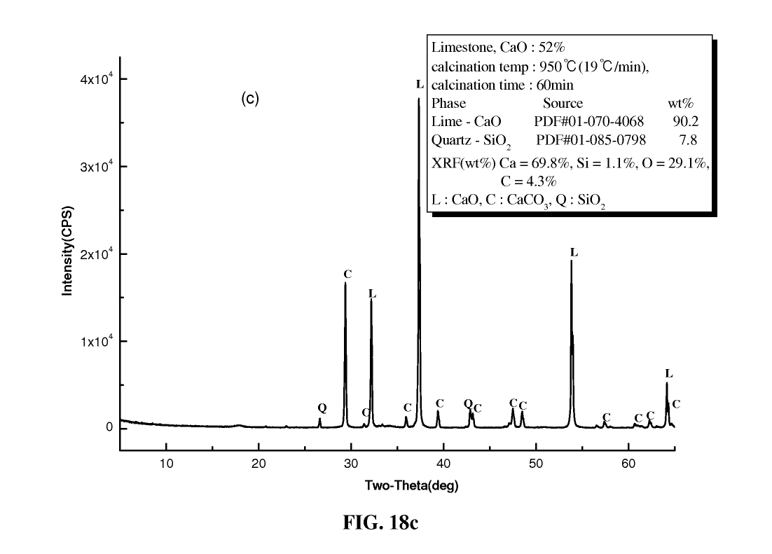

FIGS. 18a to 18c show XRD figures of quicklime which was fabricated by heating limestone of 25 mm in size (CaO: 55% (a), 53% (b), and 52% (c)) at a heating temperature of 950° C. during the heating time of 60 minutes using a conventional batch type microwave heating furnace (Comparative example 2).

Heating ratios according to experimental results of the present disclosure and of the Comparative Example shown in FIGS. 12a to 12c and FIGS. 18a to 18c are shown in Table 3 below.

TABLE 3

| | | (b) 53% | (c) 52% |
|---|---|---|---|
| | (a) 55% (limestone) | (limestone) | (limestone) |
| Comparative | CaO: 91.5% | CaO: 74.3% | CaO: 90.2% |
| Example 2 | CaCO₃: 8.5% | CaCO₃: 35.7% | CaCO₃: 3.7% |
| Embodiment 2 | CaO: 100% | CaO: 100% | CaO: 97.6% |
| | CaCO₃: 0% | CaCO₃: 0% | CaCO₃: 2.4% |

From Table 3, it can be seen that the heating ratios of the rotary type microwave heating furnace according to the present disclosure are more excellent than the heating ratios of the existing batch type microwave heating furnace. In particular, it can be seen that in the case of limestone of 55% and limestone of 53%, the heating ratio is 100% and complete heating was performed.

### Example 3

### Fabrication of Burnt Dolomite

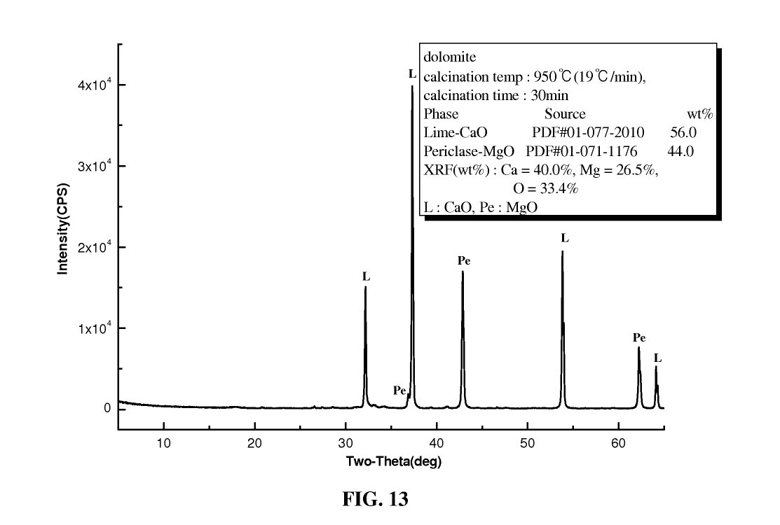

FIG. 13 shows an XRD figure of quicklime which was fabricated by heating dolomite of 25 mm in size (CaO: 33% and MgO: 21%) at a heating temperature of 950° C. during the heating time of 30 minutes in the state in which the heating element 30 was rotated at a tilt angle of 3° using the rotary type microwave heating furnace of the present disclosure (Embodiment 3).

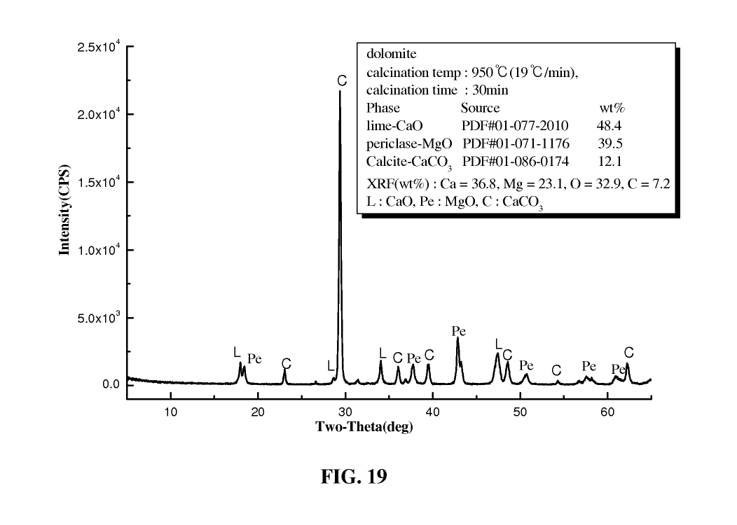

FIG. 19 shows an XRD figure of quicklime which was fabricated by heating dolomite of 25 mm in size (CaO: 33% and MgO: 21%) at a heating temperature of 950° C. during the heating time of 30 minutes using a conventional batch type microwave heating furnace (Comparative Example 3).

Heating ratios according to experimental results of the present disclosure and of the Comparative Example shown in FIGS. 13 to 19 are shown in Table 4 below.

TABLE 4

| | |
|---|---|
| | CaO: 33%, MgO: 21% |
| Comparative Example 3 | CaO: 48.4%, MgO: 39%, CaCO₃: 12.1% |
| Embodiment 3 | CaO: 56%, MgO: 44% |

From Table 4, it can be seen that the heating ratios of the rotary type microwave heating furnace according to the present disclosure are more excellent than the heating ratios of the existing batch type microwave heating furnace.

### Example 4

### Fabrication of Burnt Dolomite

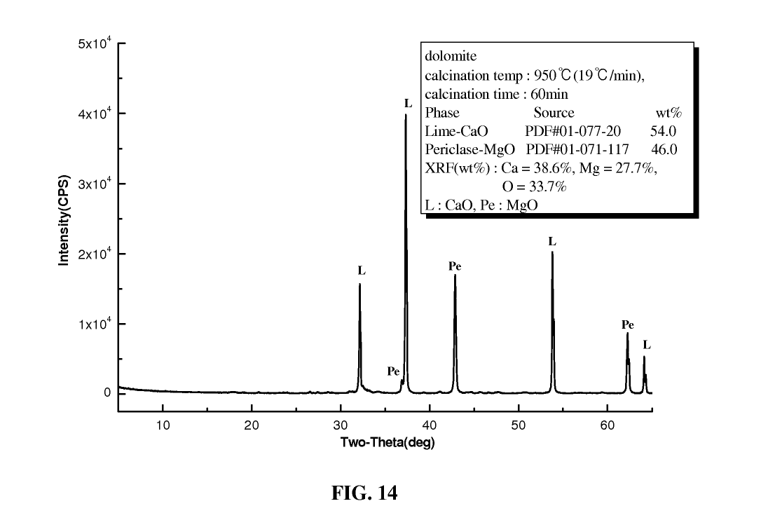

FIG. 14 shows an XRD figure of quicklime which was fabricated by heating dolomite of 25 mm in size (CaO: 33% and MgO: 21%) at a heating temperature of 950° C. during the heating time of 60 minutes in the state in which the heating element 30 was rotated at a tilt angle of 3° using the rotary type microwave heating furnace of the present disclosure (Embodiment 4).

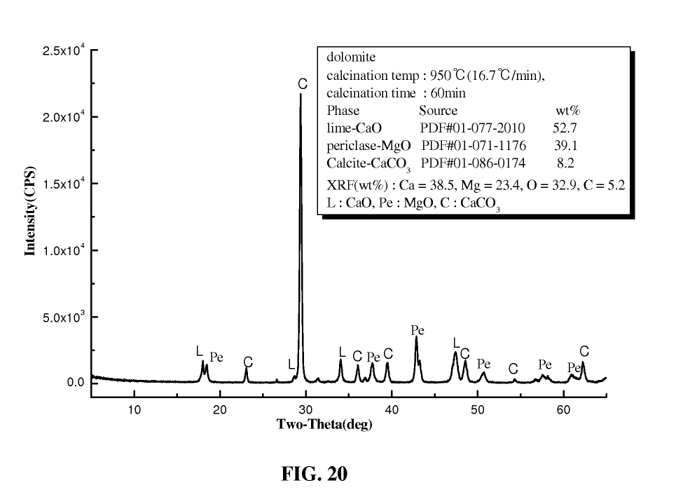

FIG. 20 shows an XRD figure of quicklime which was fabricated by heating dolomite of 25 mm in size (CaO: 33% and MgO: 21%) at a heating temperature of 950° C. during the heating time of 60 minutes using a conventional batch type microwave heating furnace (Comparative Example 4).

Heating ratios according to experimental results of the present disclosure and of the Comparative Example shown in FIGS. 19 and 20 are shown in Table 5 below.

TABLE 5

| | |
|---|---|
| | CaO: 33%, MgO: 21% |
| Comparative Example 4 | CaO: 52.7%, MgO: 39.1%, CaCO₃: 8.2% |
| Embodiment 4 | CaO: 54%, MgO: 46% |

From Table 5, it can be seen that the heating ratios of the rotary type microwave heating furnace according to the present disclosure are more excellent than the heating ratios of the existing batch type microwave heating furnace.

20 to 100 mesh power-grade calcite, from the carbonate minerals according to Embodiments and Comparative Examples applied to Examples 5 and 6 of the present disclosure, is listed in Table 6 below.

TABLE 6

Sample No

| | |
|---|---|
| 1 | ASTM. NO. 20, 20 mesh, (+)850 μm |
| 2 | ASTM. NO. 25, 24 mesh, (+)710 μm |
| 3 | ASTM. NO. 30, 28 mesh, (+)600 μm |
| 4 | ASTM. NO. 35, 32 mesh, (+)500 μm |
| 5 | ASTM. NO. 40, 35 mesh, (+)425 μm |
| 6 | ASTM. NO. 45, 42 mesh, (+)355 μm |
| 7 | ASTM. NO. 50, 48 mesh, (+)300 μm |
| 8 | ASTM. NO. 60, 60 mesh, (+)250 μm |
| 9 | ASTM. NO. 70, 65 mesh, (+)212 μm |
| 10 | ASTM. NO. 80, 80 mesh, (+)180 μm |
| 11 | ASTM. NO. 100, 100 mesh, (+)150 μm |

### Example 5

### Fabrication of Quicklime

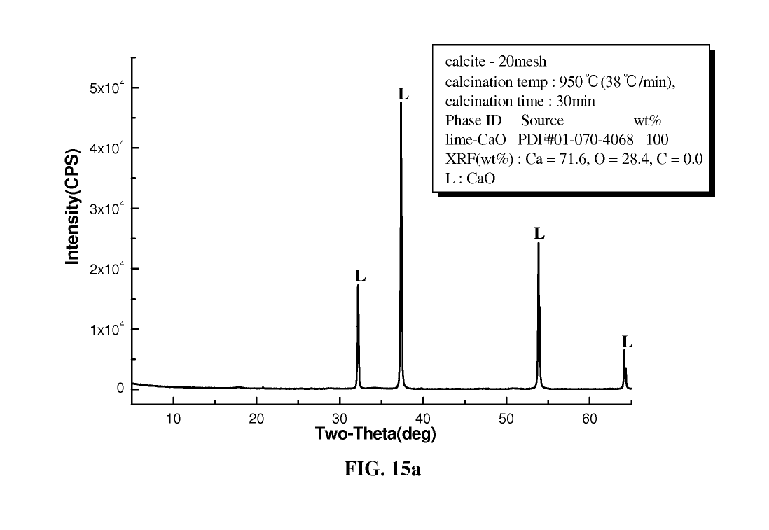

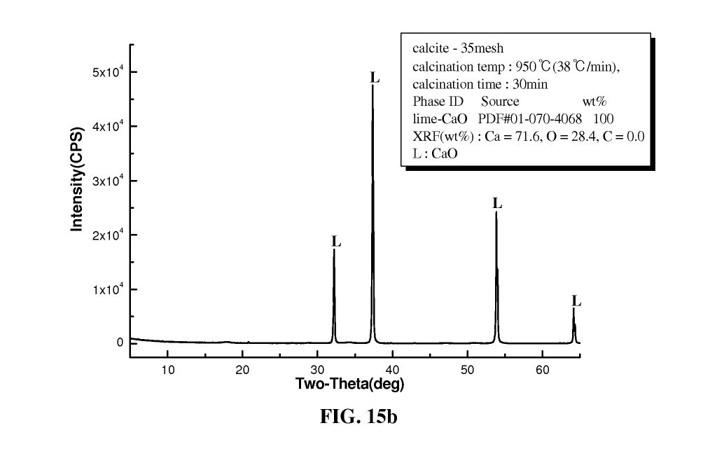

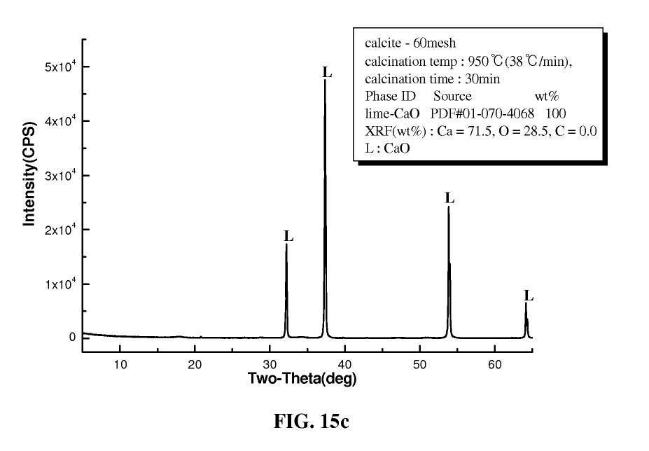

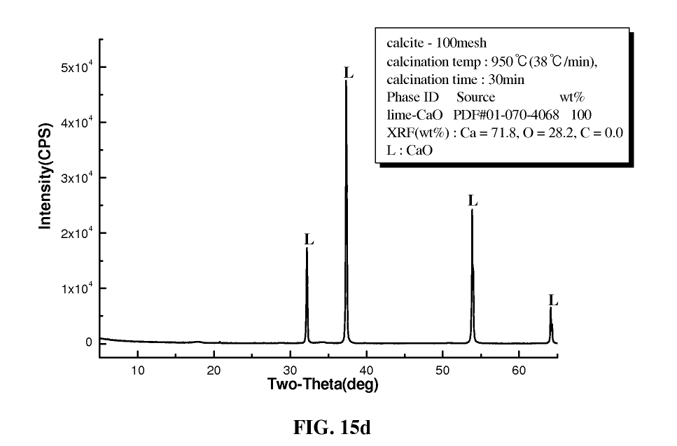

FIGS. 15a to 15d are XRD figures of quicklime which was fabricated by heating 20 mesh, 35 mesh, 65 mesh, and 100 mesh power-grade calcites, from the 20 to 100 mesh power-grade calcites (CaO 54%), at a heating temperature of 950° C. during the heating time 30 minutes in the state in which the heating element 30 was rotated at a tilt angle of 3° using the rotary type microwave heating furnace of the present disclosure (Embodiment 5).

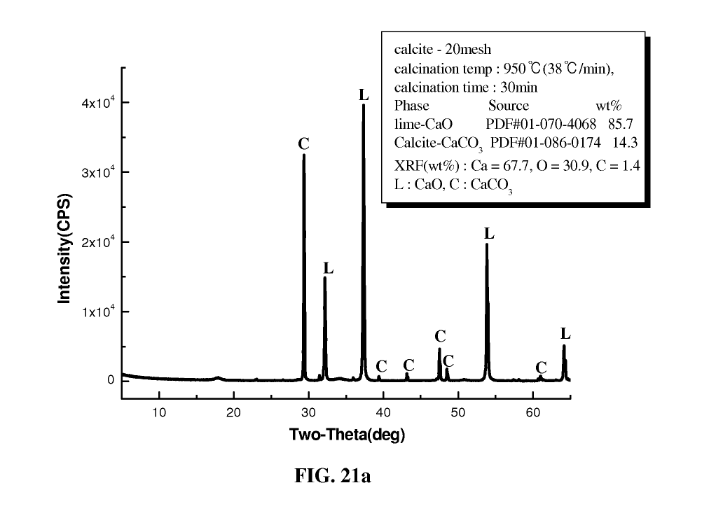

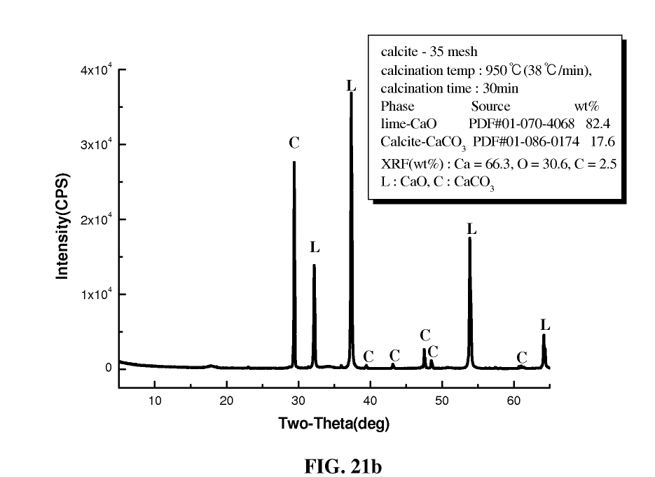

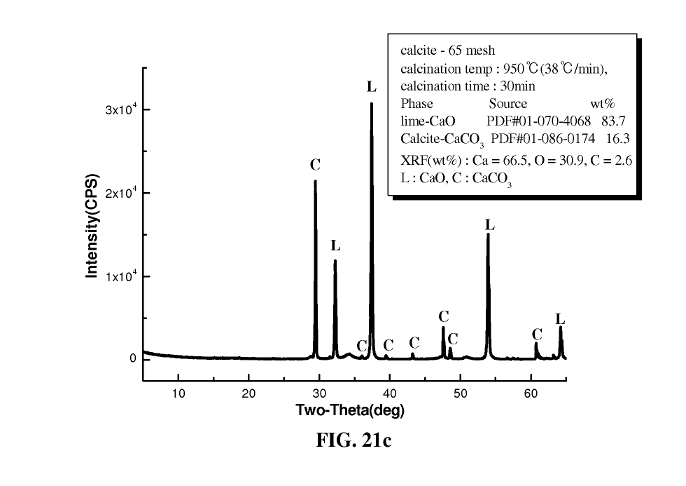

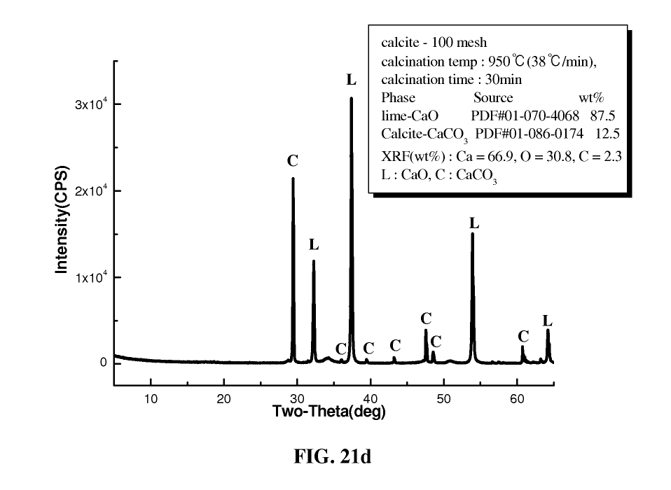

FIGS. 21a to 21d are XRD figures of quicklime which was fabricated by heating 20 mesh, 35 mesh, 65 mesh, and 100 mesh power-grade calcites, from the 20 to 100 mesh power-grade calcites (CaO 54%), at a heating temperature of 950° C. during the heating time 30 minutes using a conventional batch type microwave heating furnace (Comparative Example 5).

Heating ratios according to experimental results of the present disclosure and of the Comparative Example shown in FIGS. 15a to 15d and FIGS. 21a to 21d are shown in Table 7 below.

TABLE 7

| | 20 mesh | 35 mesh | 65 mesh | 100 mesh |
|---|---|---|---|---|
| Comparative | CaO: 85.7% | CaO: 82.4% | CaO: 83.7% | CaO: 87.5% |
| Example 5 | CaCO₃: | CaCO₃: | CaCO₃: | CaCO₃: 12.5% |
| | 14.3% | 17.6% | 16.3% | |
| Embodi- | CaO: 100% | CaO: 100% | CaO: 100% | CaCO₃: 100% |
| ment 5 | CaCO₃: 0% | CaCO₃: 0% | CaO: 0% | CaO: 0% |

From Table 7, it can be seen that the heating ratios of the rotary type microwave heating furnace according to the present disclosure have 100% in the entire 20 to 100 mesh power-grade calcites and are more excellent than the heating ratios of the existing batch type microwave heating furnace.

### Example 6

### Fabrication of Quicklime

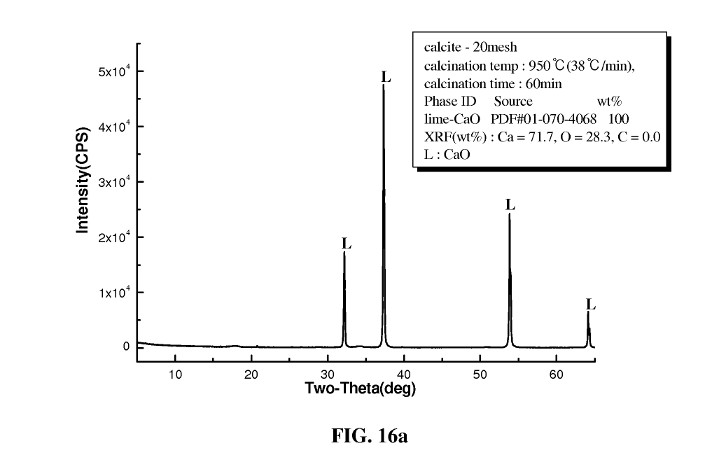

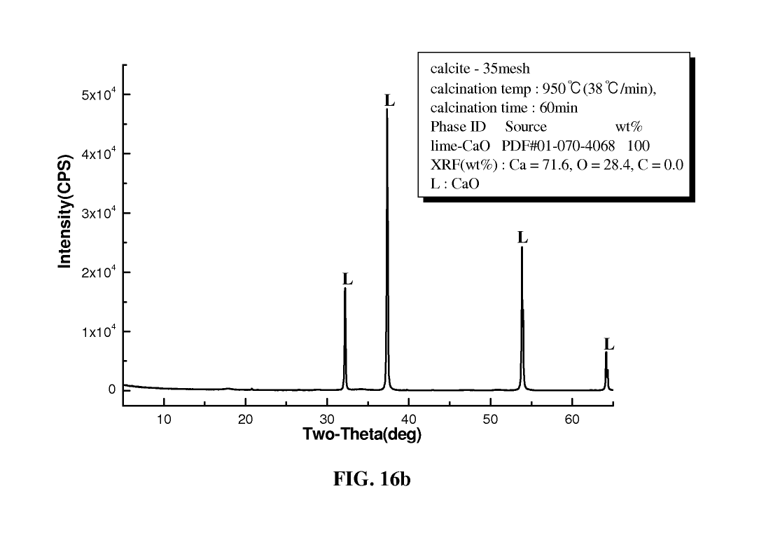

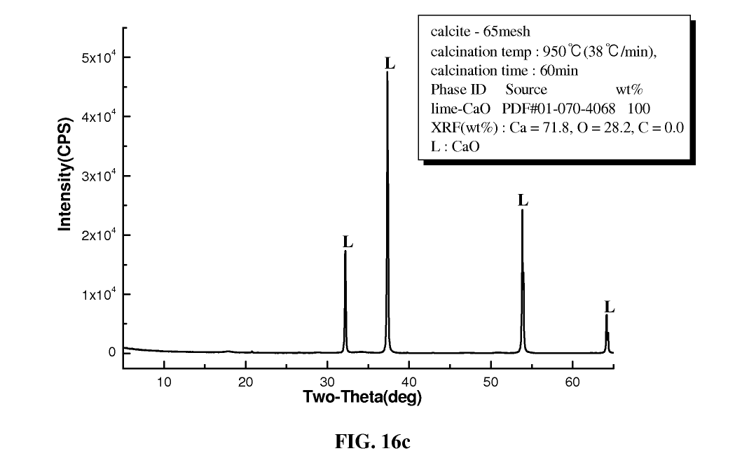

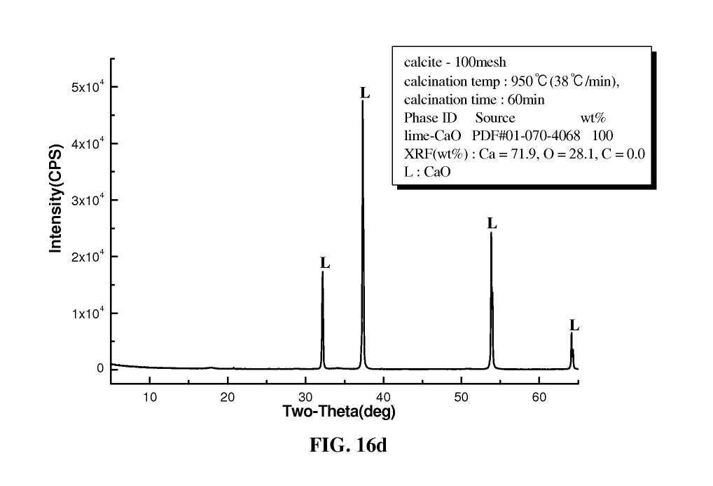

FIGS. 16a to 16d are XRD figures of quicklime which was fabricated by heating 20 mesh, 35 mesh, 65 mesh, and 100 mesh power-grade calcites, from the 20 to 100 mesh power-grade calcites (CaO 54%), at a heating temperature of 950° C. during the heating time 60 minutes in the state in which the heating element 30 was rotated at a tilt angle of 3° using the rotary type microwave heating furnace of the present disclosure (Embodiment 6).

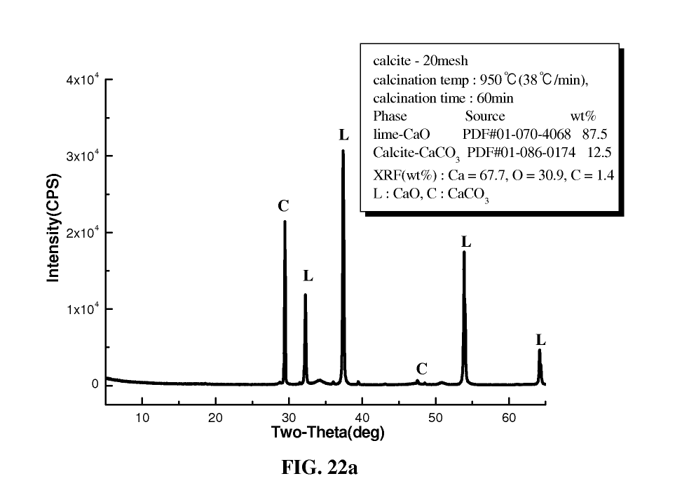

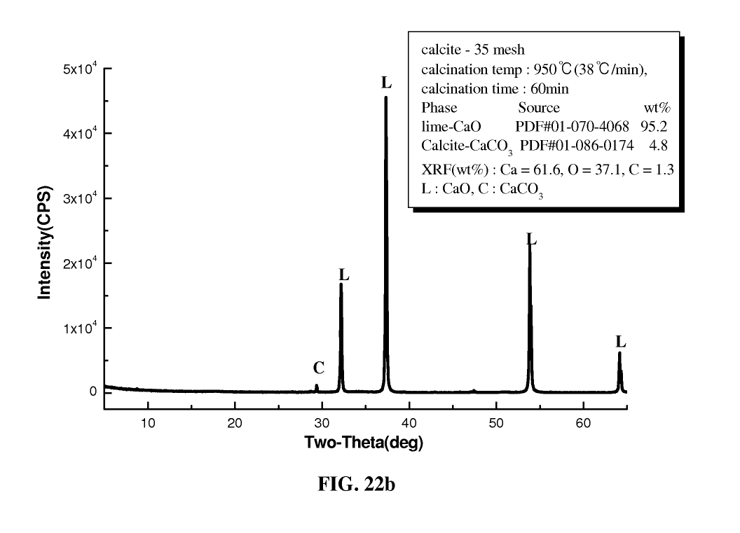

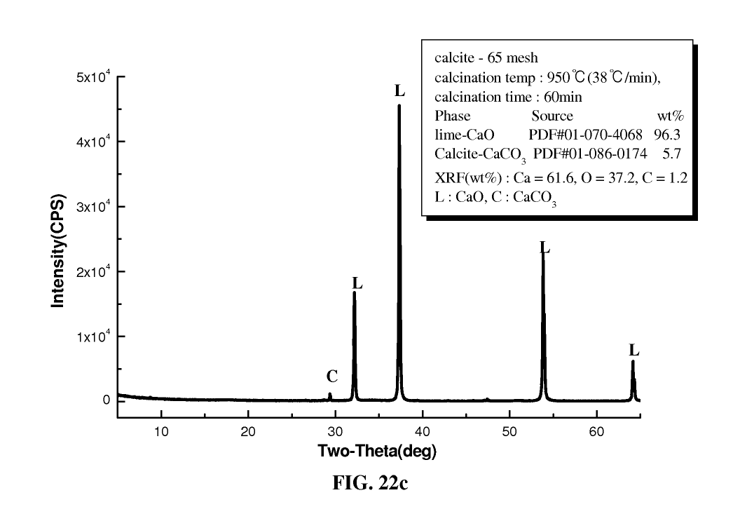

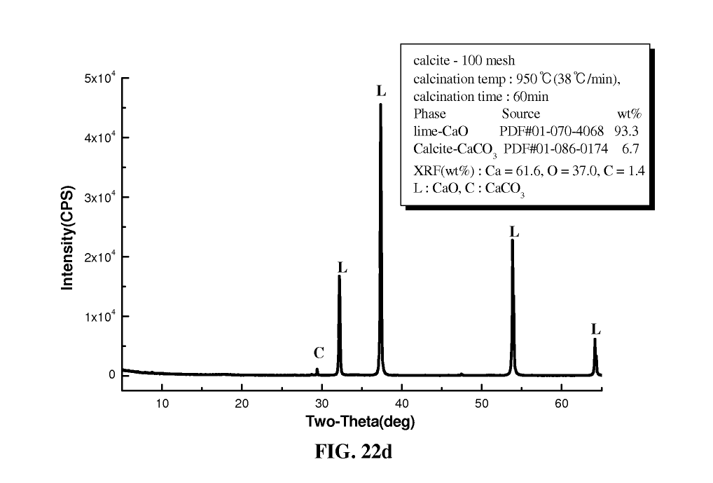

FIGS. 22a to 22d are XRD figures of quicklime which was fabricated by heating 20 mesh, 35 mesh, 65 mesh, and 100 mesh power-grade calcites, from the 20 to 100 mesh power-grade calcites (CaO 54%), at a heating temperature of 950° C. during the heating time 60 minutes using a conventional batch type microwave heating furnace (Comparative Example 6).

Heating ratios according to experimental results of the present disclosure and of the Comparative Example shown in FIGS. 16a to 16d and FIGS. 22a to 22d are shown in Table 8 below.

TABLE 8

| | 20 mesh | 35 mesh | 65 mesh | 100 mesh |
|---|---|---|---|---|
| Comparative | CaO: 87.5% | CaO: 92.2% | CaO: 96.3% | CaO: 93.3% |
| Example 6 | CaCO₃: | CaCO₃: | CaCO₃: | CaCO₃: 6.7% |
| | 12.5% | 4.8% | 5.7% | |
| Embodi- | CaO: 100% | CaO: 100% | CaO: 100% | CaCO₃: 100% |
| ment 6 | CaCO₃: 0% | CaCO₃: 0% | CaO: 0% | CaO: 0% |

From Table 8, it can be seen that the heating ratios of the rotary type microwave heating furnace according to the present disclosure have 100% in the entire 20 to 100 mesh power-grade calcites and are more excellent than the heating ratios of the existing batch type microwave heating furnace.

Consequently, it can be seen that the heating ratios of limestone and burnt dolomite using the rotary type microwave heating furnace of the present disclosure are more excellent than the heating ratios of conventional batch type microwave heating furnaces, irrespective of the size of particles according to the heating of limestone and dolomite using the rotary type microwave heating furnace of the present disclosure.

The rotary type microwave heating furnace and the heating method thereof according to the present disclosure have the following advantages.

First, temperature is uniformly distributed into the entire heating element owing to a uniform rise of temperature because microwave is radiated while the heating element is rotated by 360°. Accordingly, there is an advantage in that a desired product (quicklime) can have a uniform heating ratio because local heatwave is not generated.

Second, the heating element for providing the heating space is rotated by 360°, and thus heat is transferred to a target heating subject disposed within the heating element with the target heating subject having a direct contact with the inner circumference of the heating element. Accordingly, there are advantages in that heating ratios and energy efficiency can be improved because heating temperature can be raised and thus temperature close to a desired heating temperature can be maintained.

Third, the rotary velocity of the heating element is controlled according to the size of a target heating subject. Accordingly, there is an advantage in that heating can be uniformly performed without a limit to the size of the target heating subject because the residence time (that is, heating time) of the target heating subject can be freely controlled.

Fourth, there is an advantage in that products (quicklime) can be mass produced because the input and discharge of a target heating subject to and from the heating element can be consecutively performed during heating.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A rotary type microwave heating furnace comprising:
a cavity configured to form an airtight space to which microwave is radiated;
a microwave generation apparatus installed outside the cavity and configured to radiate microwave to an inside of the cavity;
a heating element rotatably installed within the cavity in a tilted posture and configured to have a target heating subject received therein and to provide a heating room in which the target heating subject is heated by radiation of the microwave;
a target heating subject supply apparatus installed outside the cavity, connected to an inlet side of the heating element and configured to sequentially supply the target heating subject to the heating element;
a heating element rotation apparatus installed outside the cavity, connected to an outlet side of the heating element and configured to supply power for rotating the heating element; and
a control unit configured to control an amount of the target heating subject, supplied from the target heating subject supply apparatus, and a rotary velocity of the heating element performed by the heating element rotation apparatus.

2. The rotary type microwave heating furnace as claimed in claim 1, wherein the heating element has a tilt angle of about 3° to about 5°.

3. The rotary type microwave heating furnace as claimed in claim 2, wherein
the heating element is a cylindrical pipe having a long length, and
oblique grooves are lengthily formed in an inner circumference of the heating element in a length direction in order to smooth transfer and discharge of the target heating subject accommodated in the heating element when the heating element is rotated.

4. The rotary type microwave heating furnace as claimed in claim 1, wherein the target heating subject supply apparatus comprises:
a hopper configured to have the target heating subject inputted thereto;
a transfer pipe having one end connected to a bottom of the hopper and the other end penetrating an inside of the cavity, wherein the transfer pipe is connected to the inlet side of the heating element and configured to provide a transfer path along which the target heating subject supplied from the hopper is transferred to the heating element;
a transfer screw rotatably installed within the transfer pipe and configured to transfer the target heating subject to the heating element; and
a motor configured to supply rotatory power to the transfer screw.

5. The rotary type microwave heating furnace as claimed in claim 1, wherein the heating element rotation apparatus comprises:
a pivot configured to have one end penetrate an inside of the cavity and connected to the inlet side of the heating element;
a motor providing rotatory power to the pivot; and
shaft support bearings installed at a bottom of the pivot and configured to smooth a rotation of the pivot.

6. The rotary type microwave heating furnace as claimed in claim 1, further comprising an insulator disposed between an inside of the cavity and the heating element and configured to prevent the microwave from being transmitted and prevent heat generated from the heating element from being discharged.

7. The rotary type microwave heating furnace as claimed in claim 6, wherein
a refractory cover made of refractory substance is provided on the inlet side of the heating element connected to the heating element rotation apparatus, configured to cover an end of the heating element, and connected to the pivot of the heating element rotation apparatus, and
a plurality of discharge holes is formed in a circumference direction of the refractory cover and configured to discharge the heated target heating subject toward the insulator.

8. The rotary type microwave heating furnace as claimed in claim 7, wherein
a discharge hole is formed in the insulator at a position corresponding to a position where the refractory cover is installed and configured to discharge the target heating subject, discharged from the discharge holes of the refractory cover, outside the cavity, and
a discharge pipe is penetrated from an outside of the cavity and connected to the discharge hole.

9. The rotary type microwave heating furnace as claimed in claim 1, further comprising a pair of guide rollers disposed on both sides of a lower side of the heating element and configured to support a weight of the heating element and to smooth the rotation of the heating element while coming in contact with an outer circumference of the heating element.

10. A method of heating a target heating subject using microwave, the method comprising:
heating the target heating subject by radiating microwave to the heating element, wherein a heating element forming a heating space and having the target heating subject disposed therein is rotated in a tilted posture.

11. The method as claimed in claim 10, further comprising:
forming an inlet, having the target heating subject introduced therethrough, at one end of the heating element having a high tilted position,
forming a discharge hole, having the target heating subject discharged therefrom, at the other end of the heating element having a low tilted position, and
radiating the microwave by controlling a residence time of the target heating subject, charged in the heating element, according to control of a rotary velocity of the heating element.

12. The method as claimed in claim 11, wherein the microwave is radiated in a state in which the heating element has been rotated at the tilt angle of about 3° to about 5°.

13. The method as claimed in claim 11, wherein the target heating subject is smoothly discharged along oblique grooves formed within the heating element.

14. The method as claimed in claim 11, further comprising:
forming discharge holes, having the target heating subject discharged therefrom, in a refractory cover configured to cover an outlet of the heating element and coupled to a pivot for rotating the heating element; and
discharging the heated target heating subject through the discharge holes.

15. The method as claimed in claim 11, wherein a target heating subject supply apparatus for automatically supplying the target heating subject to the heating element is connected to an inlet side of the heating element, whereby during a process of heating the target heating subject while rotating the heating element, a transfer of the target heating subject to the heating element and a discharge of the heated target heating subject from the heating element are consecutively performed.
